(19) United States
(12) Patent Application Publication
(10) Pub. No.: US 2005/0018302 A1
(43) Pub. Date: Jan. 27, 2005

(54) Optical multilayer-film filter, method for fabricating optical multilayer-film filter, optical low-pass filter, and electronic apparatus

(75) Inventors: Kunihiko Yano, Nagano (JP); Minoru Kazama, Nagano (JP); Keiko Kitamura, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/897,119

(22) Filed: Jul. 23, 2004

(30) Foreign Application Priority Data
Jul. 24, 2003 (JP) 2003-279146

(51) Int. Cl. G02B 1/10

(52) U.S. Cl. 359/588; 359/359

(57) ABSTRACT

An optical multilayer-film filter formed by laminating dielectric thin films on a transparent substrate has a structure in which a dielectric multilayer film formed by alternately laminating high-refractive-index material layers and low-refractive—index material layers is formed on one surface of the transparent substrate, a dielectric monolayer film is formed on the other surface of the transparent substrate, and the dielectric monolayer film is composed of a dielectric material having substantially the same refractive index as that of the transparent substrate. With this structure, a warp width of the substrate due to stresses of the dielectric thin films laminated in the transparent substrate can be further reduced, thereby achieving an optical multilayer-film filter which is protected from optical strain.

### TECHNICAL FIELD

The present invention relates to an optical multilayer-film filter formed by laminating dielectric thin films, a method for fabricating the optical multilayer-film filter, an optical low-pass filter, and an electronic apparatus.

### BACKGROUND ART

In recent years, image-capturing devices for video cameras, digital cameras, and the like have employed a charge coupled device (CCD).

A CCD is sensitive to light in a relatively wide wavelength region. That is, a CCD is sensitive not only to light in a visible region but also in a near-infrared region (750-2500 nm). However, the light in the infrared region is invisible to the human eye and unnecessary for the normal use of a camera. Furthermore, near-infrared light incident on an image-capturing device causes problems such as a reduction in resolution and an unevenness in an image. To cut out the near-infrared part of the incident light, an infrared-cut filter such as a sheet of color glass may be inserted in optical systems for video cameras and the like.

It is desirable to reduce the size of the optical system in such a camera, for the sake of providing increasingly miniaturized electronic devices. An infrared-cut filter composed of color glass, however, is an independent component, and its own respective size tends to limit the overall reduction in size that can be achieved in the optical system. One example of a proposal to overcome this problem appears in Japanese Unexamined Patent Application Publication No. 5-207350. According to this proposal, the size of the optical system is reduced by integrating an infrared-cut filter, composed of a dielectric multilayer film, with a lens or a low-pass filter. This eliminates the infrared-cut filter as an independent component.

Japanese Unexamined Patent Application Publication No. 7-209516 proposes the use of an optical multilayer-film filter. Under this proposal, at least 40 layers of two dielectric multilayer films are formed on both surfaces of a transparent substrate. Each surface has high-refractive-index material layers and low-refractive-index material layers alternately laminated thereon. This helps reduce warping due to the stress of the films, and helps prevent optical strain.

However, such an optical multilayer-film filter is problematic to manufacture because the two dielectric multilayer films have large and mutually different numbers of layers. Furthermore, the layers must be laminated on both surfaces of the transparent substrate, requiring that the respective films be formed on both surfaces accurately enough to satisfactorily meet the requirements of the respective optical characteristics. Also, this kind of proposed filter has a problem from the viewpoint of a tradeoff with the optical characteristics. That is to say, this kind of filter is unlikely to achieve a well-balanced relation between the stresses of the dielectric multilayer films laminated on both surfaces of the transparent substrate, thereby leading to an unsatisfactory reduction in the warp width of the transparent substrate.

### SUMMARY OF THE INVENTION

One object of the present invention, among others, is to provide an optical multilayer-film filter that has better prevention of the optical strain due to stresses of the dielectric thin films laminated on the transparent substrate, and has reduced warp width of the substrate. Another object is to provide a method for fabricating such an advantageous optical multilayer-film filter.

In order to solve the above problems, an optical multilayer-film filter in accordance with a first aspect of the present invention includes a substrate allowing light to be transmitted therethrough; a dielectric multilayer film formed on one surface of the substrate by alternately laminating first and second materials having different refractive indexes from each other; and a dielectric monolayer film formed on the other surface of the substrate.

With the above-described structure, a stress of the substrate due to the dielectric multilayer film formed on the one surface of the substrate allowing light to be transmitted therethrough is made uniform by a stress of the dielectric monolayer film formed on the other surface of the substrate, thereby achieving an optical multilayer-film filter having a structure in which the substrate having a desired dielectric multilayer film laminated thereon has a warp width less than that of the above-identified optical multilayer-film filter types.

An optical multilayer-film filter in accordance with a second aspect of the present invention is a modification of that in accordance with the first aspect of the invention, characterized in that the dielectric monolayer film has substantially the same refractive index as that of the substrate.

With the above-described structure, since the refractive indexes of the substrate and the dielectric monolayer film laminated on the substrate are substantially the same as each other, or very close to each other, there is no need for a special design for the dielectric multilayer film.

Also, an optical multilayer-film filter in accordance with a third aspect of the present invention is a modification of one of those in accordance with the first and second aspects of the invention, characterized in that the dielectric monolayer film is composed of a silicon-oxide-base compound.

With the above-described structure, because of being composed of a silicon-oxide—base compound, the dielectric monolayer film provides a monolayer film shaving a strong compressive stress, thereby achieving an optical multilayer-film filter having reduced warp width.

Also, an optical multilayer-film filter in accordance with a fourth aspect of the present invention is a modification of one of those in accordance with the first to third aspects of the invention, characterized in that the dielectric multilayer film is a UV-IR cut film or an IR cut film.

With the above-described structure, there are provided a UV-IR cut filter (ultraviolet-infrared cut filter) and an IR cut filter (infrared cut filter), each having a structure in which the dielectric multilayer film formed by alternately laminating the first and second materials having mutually different refractive indexes is formed on one surface of the substrate allowing light to be transmitted therethrough, and also having a warp width less than that of a known optical multilayer-film filter.

Also, an optical multilayer-film filter in accordance with a fifth aspect of the present invention is a modification of one of those in accordance with the first to fourth aspects of the invention, characterized in that the substrate allowing light to be transmitted therethrough is a quartz crystal plate.

With the above-described structure, since the substrate allowing light to be transmitted therethrough is composed of a quartz crystal plate, there is provided an optical multilayer-film filter which serves as, for example, an optical low-pass filter having a reduced warp width and also having a structure in which desired filter functions including functions of, for example, a UV-IR cut filter and IR cut filter are integrally incorporated.

Also, an optical multilayer-film filter in accordance with a sixth aspect of the present invention is a modification of one of those in accordance with the first to fourth aspects of the invention, characterized in that the substrate allowing light to be transmitted therethrough is a glass plate.

With the above-described structure, since the substrate allowing light to be transmitted therethrough is composed of a glass plate, there is provided an optical multilayer-film filter which serves as, for example, a dustproof glass plate having a reduced warp width, for a video apparatus such as a CCD (charge coupled device) and also having a structure in which desired filter functions including functions of, for example, a UV-IR cut filter and an IR cut filter are integrally incorporated.

Also, an optical low-pass filter in accordance with a seventh aspect of the present invention includes at least one optical multilayer-film filter in accordance with the fifth aspect of the invention.

With the above-described structure, there is provided an optical low-pass filter having a structure in which a single quartz crystal plate is disposed, a 45-degree separation-type optical low-pass filter having a structure in which two quartz crystal plates are bonded to each other such that each of the optical axes thereof having an angle of 45 degrees, and a 45-degree intersection-type optical low-pass filter having a structure in which an additional quartz crystal plate having another angle of 45 degrees is used in addition to those of the 45-degree separation type optical low-pass filter, each having a reduced warp width and also a structure in which desired filter functions are integrally incorporated. The above-described structure is especially effective to an optical low-pass filter having a structure in which two or three quartz crystal plates are bonded to each other.

An electronic apparatus in accordance with an eighth aspect of the present invention has the optical multilayer-film filter in accordance with the sixth aspect of the invention incorporated therein.

Such electronic apparatuses include, for example, video apparatuses such as digital still cameras and digital video cameras, so-called portable phones with cameras, and so-called portable personal computers with cameras.

Also, an electronic apparatus in accordance with a ninth aspect of the present invention has the optical low-pass filter in accordance with the seventh aspect of the invention incorporated therein.

Such electronic apparatuses include, for example, video apparatuses such as digital still cameras and digital video cameras, so-called portable phones with cameras, and so-called portable personal computers with cameras.

Also, a method for fabricating an optical multilayer-film filter in accordance with a tenth aspect of the present invention includes the steps of: alternately laminating first and second materials having refractive indexes different from each other on one surface of a substrate that allows light to pass therethrough; and forming a dielectric monolayer film on the other surface of the substrate.

According to the method for fabricating an optical multilayer-film filter, an optical multilayer-film filter having a warp width less than-that of the known optical multilayer-film filter is easily fabricated.

It will be appreciated that, although the present invention is described by giving particular examples in relation to an optical multilayer film filter formed by laminating dielectric thin films, and in relation to a method for fabricating such an optical multilayer-film filter, and in relation to an optical low-pass filter, and in relation to an electronic apparatus, the invention is not meant to be limited to just these matters. The true breadth and scope of the invention should be ascertained by resort to the appended claims.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 is a schematic sectional view of the structure of an optical multilayer-film filter according to one embodiment of the present invention.

FIGS. 2(a), 2(b), and 2(c) provide a schematic illustration of a warped state of a glass substrate when thin films of the optical multilayer-film filter according to an embodiment of the present invention are formed on the glass substrate.

FIG. 3 illustrates the structure of an optical low-pass filter according to the present invention.

FIG. 4 is a schematic view of the optical low-pass filter according to an embodiment of the present invention, illustrating the optical axes thereof, and the directions of travel of light rays.

FIG. 5 illustrates an exemplary electronic apparatus structure according to one embodiment of the present invention.

FIG. 6 illustrates another exemplary electronic apparatus according to another embodiment of the present invention.

### DETAILED DESCRIPTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

First Embodiment

A first exemplary embodiment of the invention is taught in relation to the application of the concepts of the invention in an optical multilayer-film filter (UV-IR cut filter) which allows light in the visible wavelength region to be transmitted therethrough, and which has an excellent reflecting characteristic of absorbing very little light having wavelengths between the UV and IR wavelength regions. That is to say, very little light not longer than a predetermined wavelength, in the ultraviolet wavelength region, and light having wavelengths not shorter than a predetermined wavelength, in the infrared wavelength region, is absorbed.

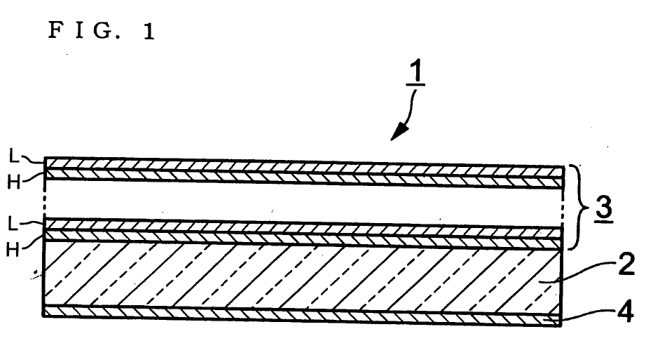

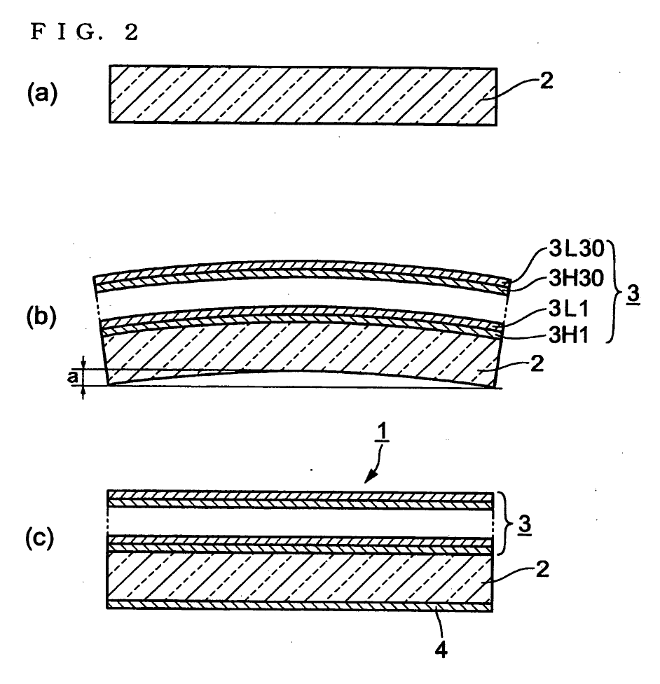

The discussion will now involve FIG. 1, which is a schematic sectional view of the structure of an optical multilayer-film filter according to an embodiment of the present invention, and FIG. 2, which illustrates a method for fabricating the optical multilayer film filter.

As shown in FIG. 1, an optical multilayer-film filter 1 has a substrate 2 allowing light to be transmitted therethrough. In this example, the substrate is glass. The filter also includes a dielectric multilayer film 3 formed on one surface of the glass substrate 2. The dielectric multilayer film 3 is formed by alternately laminating high-refractive-index material layers composed of a first material and low-refractive-index material layers composed of a second material. The filter also includes a dielectric monolayer film 4 formed on the other surface of the glass substrate 2. The dielectric monolayer film 4 is a dielectric monolayer thin film.

The glass substrate 2 is composed of a sheet of white plate glass (refractive index: n=1.52) with a diameter of 30 mm and a thickness of 0.3 mm or 0.5 mm.

The high-refractive-index material layers (H) and the low-refractive-index material layers (L) making up the dielectric multilayer film 3 are respectively composed of TiO₂ (n=2.40) and SiO₂ (n=1.46).

Referring now briefly also to FIG. 2(b), the dielectric multilayer film 3 is formed such that a film 3H1 composed of a high-refractive-index material TiO₂ is laminated on the one surface (hereafter arbitrarily referred to as the upper surface for the sake of convenience) of the glass substrate 2; a film 3L1 composed of a low-refractive-index-material SiO₂ is laminated on the upper surface of the laminated film 3H1 composed of the high-refractive-index material TiO₂. Subsequently, films composed of the high-refractive-index material TiO₂ and films composed of the low-refractive-index material SiO₂ are alternately laminated one after another beginning with the upper surface of the film 3L1. The uppermost layer of the dielectric multilayer film 3 is formed by laminating on layer 3H30 a film 3L30 composed of the low-refractive-index material SiO₂. Thus, it may be said that the dielectric multilayer film 3 has 30 layers of each type of material, that is, 60 layers in total on just the upper surface of the substrate 2.

The film thickness structure of the dielectric multilayer film 3 will now be described in detail.

In the following description of the film thickness structure, a thickness of each high-refractive-index material layer (H) is expressed by a unit of 1H representing nd=λ/4, and a thickness of each low-refractive-index material layer (L) is likewise expressed by a unit of 1L. Also, a notation S of an expression (xH,yL)^{s} indicates the number of repetitions, called stack numbers, meaning that a configuration in parentheses is cyclically repeated.

The thickness structure of the dielectric multilayer film 3 is formed by 60 layers in total such that, with a design wavelength λ of 550 nm, the film 3H1 of the high-refractive-index material TiO₂ and serving as the first layer on the upper surface of the glass substrate 2 has a thickness of 0.60H; the film 3L1 of the low-refractive-index material SiO₂ and serving as the second layer has a thickness of 0.20L; subsequently, layers having the following thicknesses are formed, one after another: 1.05H, 0.37L, (0.68H, 0.53L)⁴, 0.69H, 0.42L, 0.59H, 1.92L, (1.38H, 1.38L) 6, 1.48H, 1.52L, 1.65H, 1.71L, 1.54H, 1.59L, 1.42H, 1.58L, 1.51H, 1.72L, 1.84H, 1.80L, 1.67H, 1.77L, (1.87H, 1.87L) 7, 1.89H, 1.90L, and 1.90H one after another; and the film 3L30 composed of the low-refractive-index material SiO₂ and serving as the uppermost layer has a thickness of 0.96L. The foregoing structure thus has 60 layers in all, 30 of a material having a relatively high refractive index, and 30 of a material having a relative low refractive index, and the layers of material alternate.

The dielectric monolayer film 4 may be a monolayer film composed of SiO₂ as a silicon-oxide-base compound, formed on the other surface (lower surface) of the glass substrate 2.

Still expressing a film thickness by a unit of 1L representing an optical film thickness nd=λ/4, as in the above discussion of the film structure of the dielectric multilayer film 3, the film structure of the dielectric monolayer film 4 may be formed by a monolayer advantageously having a thickness of 12.3L with a design wavelength λ of 550 nm.

Referring more particularly to FIGS. 2(a), 2(b), and 2(c), a method for fabricating the optical multilayer-film filter according to the first embodiment will be described.

FIG. 2(a) illustrates a state in which the glass substrate 2 has no films formed thereon. The glass substrate 2 is not warped and is substantially flat.

Then, as shown in FIG. 2(b), the dielectric multilayer film 3 is formed on the one surface (upper surface) of the glass substrate 2.

One suitable method for forming the film is typical vacuum evaporation deposition.

The film structure is formed such that high-refractive-index material layers 3H1 to 3H30 composed of TiO₂ and low-refractive-index material layers 3L1 to 3L30 composed of SiO₂ are alternately formed on the upper surface of the glass substrate 2 according to the above-described film thickness structure.

The glass substrate 2 having the dielectric multilayer film 3 formed thereon may exhibit a warp in the upward direction as graphically illustrated in FIG. 2(b). This figure, which is not to scale, shows the idea of a warp width or warp amount “a”. Such a warp may result from the strong compressive stresses of the low-refractive-index material layers composed of SiO₂ and weak tensile stresses of the high-refractive-index material layers composed of TiO₂. The sum of these forces results in the surface of the dielectric multilayer film 3 having the illustrated upwardly protruding shape.

As shown in FIG. 2(c), the glass substrate 2 has a dielectric monolayer film 4 composed of SiO₂ (n=1.46) as a silicon-oxide—base compound, formed on the other surface (lower surface) of the substrate while having the dielectric multilayer film 3 formed on the one surface (upper surface).

One suitable approach to providing such a film is ion assisted deposition. This approach deposits SiO₂ on the surface of the glass substrate 2 while radiating the SiO₂ to be deposited with ions so that the dielectric monolayer film 4 has a strong compressive stress and is precisely formed.

Although an apparatus for forming the film is not shown in the figure, a known film forming apparatus such as an ion assisted deposition apparatus is used. In this kind of apparatus, the glass substrate 2 may be fixed to a film-forming susceptor in a vacuum evaporation chamber of the apparatus, a crucible filled with the low-refractive-index-material SiO₂ is disposed at the lower part of the vacuum evaporation chamber, the SiO₂ is deposited, and the glass substrate 2 is at the same time irradiated with ion beams accelerated by an electric field. Thus, the layer on the lower surface can be formed so as to have a desired thickness while being maintained in an active state.

As a result, the sum of the strong compressive stresses of the low-refractive-index material layers and weak tensile stresses of the high-refractive-index material layers, both making up the dielectric multilayer film 3, is cancelled out by a strong compressive stress of the dielectric monolayer film 4, so that the thin films formed on the glass substrate have a very small stress as a whole, whereby the optical multilayer-film filter 1 has a flatness similar to that of the a substrate having no films formed on it. This provides for an optical multilayer-film filter which is substantially not warped and which has a UV-IR cut function.

One approach to determining the thickness of the dielectric monolayer film 4 will now be mentioned. The thickness of the dielectric monolayer film 4 may be determined in accordance with the materials and thicknesses of the glass substrate 2 and the respective layers of the dielectric multilayer film 3 and the coefficient of thermal expansion of the dielectric monolayer film 4.

Another approach to determining the thickness of the monolayer film 4 is, after the glass substrate 2 has the dielectric multilayer film 3 formed thereon, to measure the actual warp width of the glass substrate 2. This may be accomplished by, for example, a flatness tester. Subsequently, the thickness of the warp-preventive dielectric monolayer film 4 may be determined so as to make the warp width flat, and the dielectric monolayer film 4 is then formed on the glass substrate 2.

Table 1 shows measured results of warp widths of sample glass substrates in the foregoing first embodiment.

As shown in Table 1, the increased warp widths, caused by the formation of the dielectric multilayer film 3, decreased after the formation of the dielectric monolayer film 4. Meanwhile, the warp widths were measured with a Highly Accurate Flatness Tester FT-900 (made by NIDEK CO., LTD).

TABLE 1

| | Warp width (unit: μm), warp direction | | |
|---|---|---|---|
| Samples | | After | After |
| (thickness of | Before | formation of | formation of |
| glass | formation of | multilayer | monolayer |
| substrate) | films | film | film |
| No. 1 (0.3 mm) | 3.84 upward | 59.62 upward | 29.28 upward |
| No. 2 (0.3 mm) | 5.21 downward | 53.40 upward | 26.36 upward |
| No. 3 (0.5 mm) | 1.54 upward | 26.40 upward | 12.40 upward |
| No. 4 (0.5 mm) | 1.43 upward | 27.03 upward | 12.24 upward |

As described above, in the optical multilayer-film filter 1 according to the present invention, the strong compressive stresses of the low-refractive-index material layers and the weak tensile stresses of the high-refractive-index material layers, both making up the dielectric multilayer film 3, are cancelled out by the strong compressive stress of the dielectric monolayer film 4. As a result, the thin films formed on the glass substrate 2 have a very small stress as a whole, so that the optical multilayer-film filter 1 is substantially not warped, has decreased problems such as delamination, crack, and so forth, and has a UV-IR cut function.

Also, since the optical multilayer-film filter 1 is substantially not warped, when two or more glass substrates in addition to at least one optical multilayer-film filter 1 are used by bonding one to another, the bonding accuracy thereof is improved. In particular, when a deformable material such as resin is inserted between these components, the amount of deformation can be minimized. The optical multilayer-film filter also serves as a dustproof glass plate including the UV-IR cut filter function, which is highly advantageous in a video or other apparatus using a CCD, when it is integrally bonded to the incident surface of the CCD.

In addition, since the dielectric monolayer film 4 is arranged so as to have a refractive index lying within ±7% of that of the glass substrate 2 and being substantially the same as that of the glass substrate 2, it is not necessary to use a special film design for the dielectric multilayer film, and a known film design is hence applicable.

It is true that the formation of the dielectric monolayer film on the glass substrate 2 causes fine ripples of the transmittance of the optical multilayer-film filter. Although large ripples prevent the optical multilayer-film filter from achieving an excellent optical characteristic, ripples of the transmittance of the optical multilayer-film filter 1 according to this embodiment fall in a fine magnification range, thereby achieving an optical multilayer-film filter that still has excellent optical characteristics.

Although the substrate in the above-described first embodiment is white plate glass, the substrate is not limited to being composed of white plate glass, and it may be a transparent substrate composed of BK7, sapphire glass, borosilicate glass, blue plate glass, SF3, or SF7. Alternatively, optical glass generally available on the market or quartz crystal may be used.

Especially, when the substrate is composed of quartz crystal, there is provided an optical multilayer-film filter which serves as, for example, an optical low-pass filter having decreased warp width and a structure in which desired filter functions including functions of, for example, a UV-IR cut filter and an IR cut filter are integrally incorporated.

Although the high-refractive-index material layers are composed of TiO₂ in the foregoing exemplary embodiment, they may alternatively be composed of, e.g., Ta₂O₅ or Nb₂O₅.

Although the low-refractive-index material layers in the foregoing exemplary embodiment are composed of SiO₂, they may alternatively be composed of, e.g., MgF₂.

Although the dielectric monolayer film 4 is composed of SiO₂ in the foregoing exemplary embodiment, it may alternatively be composed of Al₂O₃.

According to the above-described fabrication method, the dielectric multilayer film 3 is first formed on the one (upper) surface of the glass substrate 2, and the dielectric monolayer film 4 is then formed on the other (lower) surface of the glass substrate 2 after the dielectric multilayer film 3 is already formed. Alternatively, the dielectric monolayer film 4 may first be formed on one surface of the glass substrate 2, and the dielectric multilayer film 3 may be then formed on the other surface.

Although the dielectric monolayer film 4 in the first embodiment is formed by ion assisted deposition, it may alternatively be formed by ion plating, which is likewise suitable for precisely forming a film, in the same fashion as ion assisted deposition.

Second Embodiment

A second embodiment of the optical multilayer film filter according to the present invention will be described below.

The second embodiment is different, from the first embodiment only in that the substrate is composed of quartz crystal.

The substrate allowing light to be transmitted therethrough is composed of a piece of quartz crystal (transmittance: n=1.52) having a two-dimensional size of 48 mm×43 mm and a thickness of 0.43 mm. The second embodiment is one embodiment applied to a UV-IR cut filter while being arranged such that the conditions thereof other than the material of the substrate are generally the same as those in the first embodiment.

The quartz crystal substrate having the dielectric multilayer film 3 formed thereon tends to be upwardly warped due to the strong compressive stresses of the low-refractive-index material layers (composed, e.g., of SiO₂) and the weak tensile stresses of the high-refractive-index material layers (composed, e.g., of TiO₂). The dielectric multilayer film 3 thus tends to have a surface with an upwardly protruding shape.

Next, with the dielectric multilayer film 3 being already formed on one surface of the quartz crystal substrate, a dielectric monolayer film 4 composed, e.g., of SiO₂ (n=1.46) as a silicon-oxide—base compound is formed on the other surface of the quartz crystal substrate by, e.g., ion assisted deposition.

As a result, since the warp-inducing stresses of the dielectric monolayer film 4 cancel out those of the dielectric multilayer film 3, the warp width of the optical multilayer-film filter decreases after formation of the dielectric monolayer film.

Table 2 shows measured results of the warp widths of sample quartz crystal substrates in the foregoing second embodiment.

The warp widths were measured with a Highly Accurate Flatness Tester FT-900 (made by NIDEK CO., LTD).

Since the optical multilayer-film filter according to the second embodiment has a structure in which the transparent substrate is composed of a quartz crystal plate as described above, it is suitable to serve as, for example, an optical low-pass filter having decreased warp and also having a structure in which an integral UV-IR cut filter function.

TABLE 2

| | Warp width (unit: μm), warp direction | | |
|---|---|---|---|
| Samples | | After | |
| (thickness of | Before | formation of | After |
| quartz crystal | formation of | multilayer | formation of |
| substrate) | films | film | monolayer film |
| No. 1 (0.43 mm) | 4.39 upward | 126.14 upward | 11.93 upward |
| No. 2 (0.43 mm) | 8.48 upward | 130.57 upward | 13.83 upward |

A third embodiment of the optical multilayer-film filter according to the present invention will be described below.

The third embodiment is one embodiment applied to an optical multilayer-film filter (IR cut filter) which allows light in the visible wavelength region to be transmitted therethrough and has an excellent reflecting characteristic of absorbing little light in the infrared wavelength region, having wavelengths not shorter than a predetermined wavelength.

The third embodiment is different from the first embodiment only in the number of film layers and the film thickness structure of the dielectric multilayer film 3 formed on the upper surface of the glass substrate 2 and the film thickness structure of the dielectric monolayer film 4 formed on the lower surface of the glass substrate 2.

A method for forming films on the glass substrate in the third embodiment will be described below. With respect to the formation of the dielectric multilayer film 3 on the glass substrate 2, each high-refractive-index material layer (H) is composed of TiO₂ and each low-refractive-index material layer (L) is composed of SiO₂. A suitable method for forming the film is a typical vacuum evaporation deposition.

Similar to the first embodiment, in the following description of the film thickness structure, a thickness of each high-refractive-index material layer (H) is expressed by a unit of 1H representing nd=λ/4, and a thickness of a low-refractive-index material layer (L) is likewise expressed by a unit of 1L. Also, a notation S of an expression (xH,yL)^{s} indicates the number of repetitions, called stack numbers, meaning that a configuration in parentheses is cyclically repeated.

The thickness structure of the dielectric multilayer film 3 is formed by 40 layers in total, with a design wavelength λ of 755 nm, having thicknesses of 1.14H, 1.09L, 1.03H, 1.01L, (0.99H, 0.99L) ⁶, 1.02H, 1.08L, 1.31H, 0.18L, 1.37H, 1.24L, 1.27H, 1.28L, (1.28H, 1.28L)⁶, 1.26H, 1.28L, 1.25H, and 0.63L (from the glass substrate upward, one after another).

The glass substrate 2 having the dielectric multilayer film formed thereon is upwardly warped due to the strong compressive stresses of the low-refractive-index material layers composed of SiO₂ and the weak tensile stresses of the high-refractive-index material layers composed of TiO₂, so that the surface of the dielectric multilayer film 3 has an upwardly protruding shape.

Next, the dielectric monolayer film composed of SiO₂ is formed on the glass substrate 2 by ion assisted deposition.

When the film thickness of the low-refractive index layer (L) is expressed by a unit of 1L representing an optical film thickness nd=λ/4, the film thickness structure consists of a monolayer formed on the lower surface of the glass substrate, having a thickness of 8.2L with a design wavelength λ of 550 nm.

The glass substrate 2 having the dielectric monolayer film 4 formed thereon is upwardly warped due to the strong compressive stress of SiO₂, so that the surface of the dielectric monolayer film 4 has an upwardly protruding shape.

As a result, since the warping force of the dielectric monolayer film cancels out the warping force of the dielectric multilayer film, the warp width of the optical multilayer-film filter decreases after formation of the dielectric monolayer film.

Table 3 shows measured results of warp widths of sample glass substrates in the foregoing third embodiment. These warp widths were measured with a Highly Accurate Flatness Tester FT-900 (made by NIDEK CO., LTD).

Such an optical multilayer-film filter may advantageously serve as a dustproof glass plate which includes an IR cut filter function, especially for a video apparatus that uses a CCD. Such a filter may be integrally bonded to the incident surface of the CCD.

TABLE 3

| | Warp width (unit: μm), warp direction | | |
|---|---|---|---|
| Samples | | After | |
| (thickness of | Before | formation of | After |
| glass | formation of | multilayer | formation of |
| substrate) | films | film | monolayer film |
| No. 1 (0.3 mm) | 4.39 upward | 45.55 upward | 17.21 upward |
| No. 2 (0.3 mm) | 4.87 downward | 43.70 upward | 19.02 upward |
| No. 3 (0.5 mm) | 2.47 downward | 18.98 upward | 8.06 upward |
| No. 4 (0.5 mm) | 1.03 upward | 17.72 upward | 7.12 upward |

Fourth Embodiment

A fourth embodiment of the optical multilayer-film filter according to the present invention will be described below.

The fourth embodiment is different from the third embodiment in that the substrate is composed of quartz crystal.

The substrate allowing light to be transmitted therethrough is composed of a piece of quartz crystal (transmittance: n=1.52) having a two-dimensional size of 48 mm×43 mm and a thickness of 0.43 mm. The fourth embodiment is one embodiment applied to an IR cut filter while being arranged such that all conditions thereof other than the material of the substrate are the same as those of the third embodiment.

The quartz crystal substrate having the dielectric multilayer film formed thereon is upwardly warped due to strong compressive stresses of the low-refractive-index material layers composed of SiO₂ and weak tensile stress of the high-refractive-index material layers composed of TiO₂, so that the surface of the dielectric multilayer film has an upwardly protruding shape.

The dielectric monolayer film 4 composed of SiO₂ (n=1.46) as a silicon-oxide—base compound is disposed on the other surface of the quartz crystal substrate by ion assisted deposition.

As a result, since a warp of the dielectric monolayer film 4 cancels out that of the dielectric multilayer film 3, the warp width of the optical multilayer-film filter decreases after the formation of the dielectric monolayer film.

Table 4 shows measured results of warp widths of sample quartz crystal substrates in the foregoing fourth mbodiment.

The warp widths were measured with a Highly Accurate Flatness Tester FT-900 (made by NIDEK CO., LTD).

Since the optical multilayer-film filter according to the fourth embodiment has a structure in which the transparent substrate is composed of a quartz crystal plate as described above, it may advantageously serve as an optical low-pass filter with a structure in which-desired-filter functions such as an IR-cut filter are integrally incorporated.

TABLE 4

| | Warp width (unit: μm), warp direction | | |
|---|---|---|---|
| Samples | | After | After |
| (thickness of | Before | formation of | formation of |
| quartz crystal | formation of | multilayer | monolayer |
| substrate) | films | film | film |
| No. 1 (0.43 mm) | 9.91 upward | 97.68 upward | 14.04 upward |
| No. 2 (0.43 mm) | 4.49 upward | 95.08 upward | 13.19 upward |

### Fifth Embodiment

Next, one embodiment of an optical low-pass filter according to the present invention will be described.

The optical low-pass filter is an embodiment in which the optical multilayer-film filter (UV-IR cut filter) according to the second embodiment is used.

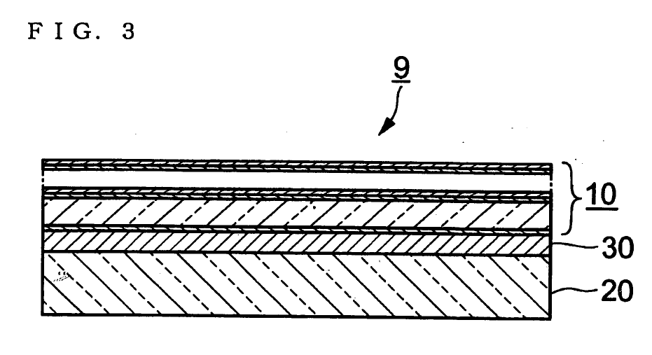

FIG. 3 illustrates the structure of the optical low-pass filter including a function of an optical multilayer-film filter.

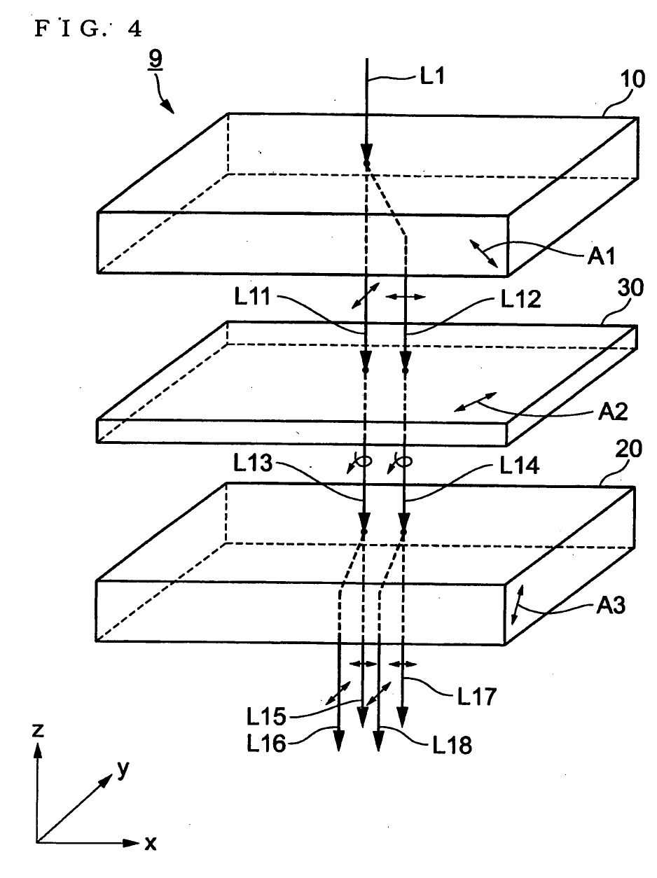

FIG. 4 is a schematic view of the optical low-pass filter including the optical multilayer-film filter according to the present invention, illustrating the optical axis thereof and the direction of travel of a light ray, wherein layers making up the optical low-pass filter are illustrated by means of an exploded perspective view.

As shown in FIG. 3, an optical low-pass filter 9 according to this embodiment has a three-layer structure including two quartz crystal plates 10 and 20 serving as birefringent plates and a quarter wave plate 30 also composed of quartz crystal and interposed between the two quartz crystal plates 10 and 20.

The quartz crystal plate 10 is the optical multilayer-film filter according to the foregoing second embodiment, having a structure in which the transparent substrate is composed of quartz crystal and has the dielectric multilayer film formed on one (upper) surface thereof and the dielectric monolayer film formed on the other (lower) surface thereof. The quartz crystal plate 10, the quarter wavelength plate 30, and the quartz crystal plate 20 form the three layer structure and are bonded to one another so as to have an integral structure.

Referring next to FIG. 4, the optical axis of the optical low-pass filter 9 and the direction of travel of a light ray will be described.

The quartz crystal plate 10 disposed on the light-incident side lies orthogonal to the light-incident surface of the optical low-pass filter and also has an optical axis (optical main axis) extending along the x-z plane, parallel to the plane of the figure, and in a direction (shown by the arrow Al indicated in the figure) making an angle of 45 degrees with the z axis. A light ray L1 incident on the quartz crystal plate 10 is separated into two light rays L11 and L12 due to birefringence of the quartz crystal plate 10, and the separated light rays L11 and L12 are linearly polarized and are emitted.

The quarter wavelength plate 30 has an optical axis extending along the light-incident surface (the x-y plane) and in a direction (shown by the arrow A2 indicated in the figure) making an angle of 45 degrees with the x axis. With this arrangement, the linearly polarized light rays L11 and L12 incident on the quarter wavelength plate 30 are circularly polarized and are emitted as light rays L13 and L14, respectively.

The quartz crystal plate 20 disposed on the light-emitting side lies orthogonal to the light-incident surface and also has an optical axis along the plane (the y-z plane) orthogonal to the plane of the figure, and in a direction (shown by the arrow A3 indicated in the figure) making an angle of 45 degrees with the y axis. The light rays L13 and L14 incident on the quartz crystal plate 20 are respectively separated into two light rays L15 and L16 and two light rays L17 and L18 due to birefringence of the quartz crystal plate 20 (similarly to the quartz crystal plate 10), and these separated light rays L15, L16, L17, and L18 are thereby linearly polarized and emitted.

In the optical low-pass filter 9 having the above-described structure, the desired filter functions including a UV-IR cut filter function are integrally incorporated.

Especially, with the structure in which the quartz crystal plates serving as components are integrally bonded to each other as described in this embodiment, there is provided an optical low-pass filter which has very little warp, and in which optical strain is prevented.

### Sixth Embodiment

Next, an electronic apparatus including the optical multilayer-film filter according to the third embodiment will be described.

This embodiment is one embodiment applied to, for example, a video apparatus of a digital still camera as an electronic apparatus, for taking a picture of a still image.

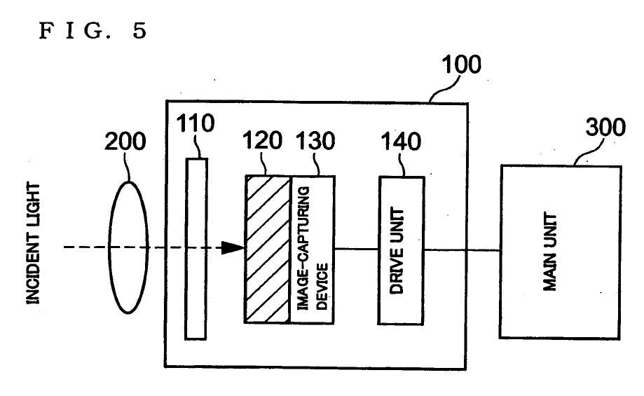

FIG. 5 is an illustration of an exemplary structure of an electronic apparatus according to the present invention, illustrating example structures of an image capturing module and an image capturing apparatus including the image capturing module.

An image-capturing module 100 shown in FIG. 5 is formed by an optical low-pass filter 110, an optical multilayer-film filter 120, a CCD 130 serving as an image-capturing device for electrically converting an optical image, and a drive unit 140 for driving the image-capturing device 130.

The optical multilayer-film filter 120 is the optical multilayer-film filter according to the above-described third embodiment of to the present invention, which is formed by the glass substrate 2, the dielectric multilayer film 3 formed on one surface of the glass substrate 2 by alternately laminating high-refractive-index material layers and low-refractive-index material layers, and the dielectric monolayer film 4 formed on the other surface of the glass substrate 2 and formed by a dielectric monolayer thin film, and which has a function of an IR cut filter. The optical multilayer-film filter 120 is bonded to the front surface of the CCD 130, integrally with the CCD 130, and serves as a dustproof glass plate for the CCD 130.

The image capturing apparatus includes the image-capturing module 100, a lens 200 disposed on the light incident side, and a main unit 300 performing record-playback of an image signal outputted from the image-capturing module 100 and so forth. Meanwhile, although not shown in the figure, the main unit 300 includes components such as a signal processing unit performing correction of an image-capturing signal and so forth, a recording unit recording the image capturing signal into a recording medium such as a magnetic tape, a playback unit playing back the image-capturing signal, and, a display unit displaying a played-back video image.

The digital still camera having the above-described structure has excellent bonding accuracy and an excellent optical characteristic because of being equipped with the optical multilayer-film filter 120 having a structure in which the CCD 130 and functions of a dustproof glass plate and an IR cut filter are integrally incorporated.

Meanwhile, although the image-capturing module 100 according to the embodiment is disposed independent from the lens 200, the image-capturing module may have the lens 200 incorporated therein.

Seventh Embodiment

Next, an electronic apparatus including the optical low-pass filter according to the fifth embodiment will be described.

This embodiment is one embodiment applied to, for example, a video apparatus of a digital still camera as an electronic apparatus, for taking a picture of a still image.

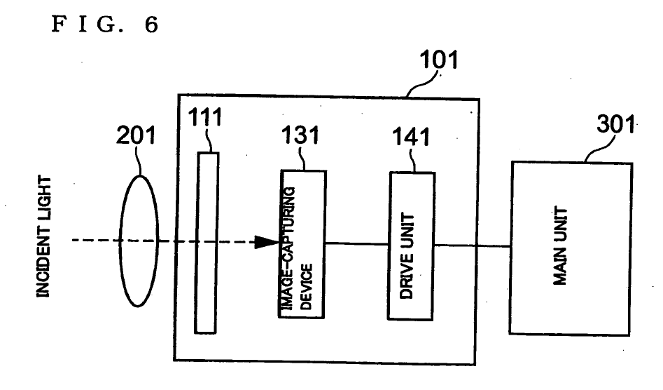

FIG. 6 is an illustration of an exemplary structure of another electronic apparatus according to the present invention, illustrating an image-capturing module and an example structure of an example structure of an image capturing apparatus including the image-capturing module.

An image-capturing module 101 shown in FIG. 6 is formed by an optical low-pass filter 111 of the same structure described in the foregoing fifth embodiment, a CCD 131 serving as an image-capturing device for electrically converting an optical image, and a drive unit 141 for driving the CCD 131.

The image capturing apparatus includes the image-capturing module 101, a lens 201 disposed on the light incident side, and a main unit 301 performing record-playback of an image signal outputted from the image-capturing module 101 and so forth. Meanwhile, although not shown in the figure, the main unit 301 includes components such as a signal processing-unit performing correction of an image-capturing signal and so forth, a recording unit recording the image capturing signal into a recording medium (such as, e.g., a magnetic tape), a playback unit playing back the image-capturing signal, and a display unit displaying a played-back video image.

The digital still camera having the above-described structure and serving as an electronic apparatus displays a clear image from which an optical false (moire) is reliably eliminated because of being equipped with the optical low-pass filter of the present invention, which has very little warp, and in which optical strain is prevented.

Meanwhile, although the image-capturing module 101 according to the embodiment is disposed independent from the lens 201, the image-capturing module may have the lens 201 incorporated therein.

Although a digital still camera is employed as an example of an electronic apparatus in this embodiment, a variety of devices can be formed by using an optical low-pass filter according to the invention, such devices including, without limitation a video apparatus of a digital camera for capturing a moving image, an image-capturing unit of a so-called portable phone with a camera, an image-capturing unit of a so-called portable personal computer with a camera, and the like.

According to the present invention, there is provided an optical multilayer-film filter having a structure in which a stress of the substrate due to the dielectric multilayer film formed on one surface of the substrate is made uniform by the stress of a dielectric monolayer film formed on the other surface of the substrate, and thus the warp width of the substrate having the desired dielectric multilayer film laminated thereon is reduced more than in any known optical multilayer-film filter.

Also, with the method according to the present invention, for fabricating an optical multilayer-film filter, an optical multilayer-film filter having a warp width less than that of other known optical multilayer-film filters can be fabricated with relative ease.

Also, the optical low-pass filter according to the present invention has desired filter functions integrally incorporated therein, and is thus warped only a little, and is protected from optical strain.

Also, an electronic apparatus according to the present invention provides, for example, a digital still camera which displays a clear image from which an optical false signal is reliably eliminated by including, for example, an optical low-pass filter having reduced warp, or a digital still camera having excellent optical characteristics and excellent bonding accuracy because of a structure in which the functions of a dustproof glass plate and an IR cut filter are integrally incorporated.

It will be appreciated that the dielectric monolayer film 4 may be thought of as a means for reducing warp.

Many variations to the above-identified embodiments are possible without departing from the scope and spirit of the invention. Some of the possible variations have been presented throughout the foregoing discussion. Cpmbinations and subcombinations of the various embodiments described above will occur to those familiar with this field, without departing from the scope and spirit of the invention.

1. An optical multilayer-film filter, comprising;
a substrate allowing light to be transmitted therethrough;
a dielectric multilayer film formed on one surface of the substrate by alternately laminating first and second materials having respective refractive indexes, the respective refractive index of the first material being different from the respective refractive index of the second material; and
a dielectric monolayer film formed on the other surface of the substrate.

2. An optical multilayer-film filter according to claim 1, wherein the dielectric monolayer film has a respective refractive index substantially the same as a respective refractive index of the substrate.

3. An optical multilayer-film filter according to claim 1, wherein the dielectric monolayer film is composed of a silicon-oxide—base compound.

4. An optical multilayer-film filter according to claim 1, wherein the dielectric multilayer film is one of a UV-IR cut film and an IR cut film.

5. An optical multilayer-film filter according to any one of claims 1 to 4, wherein the substrate allows light to be transmitted therethrough and is a quartz crystal plate.

6. An optical multilayer-film filter according to any one of claims 1 to 4, wherein the substrate allows light to be transmitted therethrough and is a glass plate.

7. An optical low-pass filter, comprising at least one optical multilayer-film filter according to claim 5.

8. An electronic apparatus having the optical multilayer-film filter according to claim 6 incorporated therein.

9. An electronic apparatus having the optical low-pass filter according to claim 7 incorporated therein.

10. A method for fabricating an optical multilayer-film filter, comprising:
providing a substrate allowing light to be transmitted therethrough;
alternately laminating, on one surface of the substrate first and second materials having respective refractive indexes, the respective refractive index of the first material being different from the respective refractive index of the second material; and
forming a dielectric monolayer film on the other surface of the substrate.

11. An electronic apparatus, comprising:
an image capturing module; and
a main unit controlling the image capturing module;
wherein:
the image capturing module includes an optical filter having a substrate;
the substrate has a dielectric multilayer film on one surface, and means for reducing warp on another surface.

12. The electronic apparatus as set forth in claim 11, wherein the electronic apparatus is one or more of a digital still camera, a digital video camera, a phone with a camera, and a personal computer with a camera.

13. The electronic apparatus as set forth in claim 11, wherein the means for reducing warp is a dielectric monolayer film.

14. The electronic apparatus as set forth in claim 11, wherein the dielectric multilayer film has a plurality of layers of a first material and a plurality of layers of a second material, and wherein a refractive index of the first material is higher than a refractive index of the second material.

15. The electronic apparatus as set forth in claim 14, wherein the layers of the first material and the layers of the second material are alternately disposed one on top of another.

16. The electronic apparatus as set forth in claim 14, wherein the layers of the first material comprise one of TiO₂, Ta₂O₅, and Nb₂O₅.

17. The electronic apparatus as set forth in claim 14, wherein the layers of the second material comprise one of SiO₂ and MgF₂.

18. The electronic apparatus as set forth in claim 14, wherein the substrate comprises one of white plate glass, BK7, sapphire glass, borosilicate glass, blue plate glass, SF3, SF7, and quartz crystal.

19. The electronic apparatus as set forth in claim 14, wherein the means for reducing warp comprises a dielectric monolayer film.

20. The electronic apparatus as set forth in claim 19, wherein the means for reducing warp consists of a dielectric monolayer film of one of SiO₂ and Al₂O₃.
